(19) United States
(12) Patent Application Publication
(10) Pub. No.: US 2025/0045360 A1
(43) Pub. Date: Feb. 6, 2025

(54) SYSTEM FOR DISTRIBUTED DATA PROCESSING USING CLUSTERING

(71) Applicant: Centrica PLC, Windsor (GB)

(72) Inventors: Sathiskumar JOTHI, Berkshire (GB); Ayan GANGULY, Berkshire (GB); Chelle CANE, Berkshire (GB)

(73) Assignee: Centrica PLC, Windsor (GB)

(21) Appl. No.: 18/923,908

(22) Filed: Oct. 23, 2024

Related U.S. Application Data
(63) Continuation of application No. 16/930,798, filed on Jul. 16, 2020, now abandoned.

(30) Foreign Application Priority Data
Jul. 19, 2019 (GB) 1910401.7

(51) Int. Cl. G06F 18/231; G06F 16/28; G06F 18/10; G06F 18/22; G06F 18/23213; G06F 18/2413

(52) U.S. Cl. CPC G06F 18/231; G06F 16/285; G06F 18/10; G06F 18/22; G06F 18/23213; G06F 18/24137

(57) ABSTRACT

Disclosed is a control system for a smart home environment comprising one or more devices connected to the control system via a communications network. The control system receives a plurality of data records from the one or more devices and transmits data from the data records to a remote processing system for analysis. The system receives cluster specification data from the remote processing system-defining a plurality of data clusters relating to the data records, the data clusters derived by the remote processing system at least in part based on the transmitted data. The control system subsequently receives additional data records from the one or more devices and classifies the additional data records by allocating the data records to one or more clusters of the data clusters based on the cluster specification data. The control system controls at least one device in the smart home environment by cluster allocation.

### CROSS-REFERENCE TO RELATED APPLICATIONS

This application is a U.S. continuation application of U.S. patent application Ser. No. 16/930,798, entitled SYSTEM FOR DISTRIBUTED DATA PROCESSING USING CLUSTERING, filed Jul. 16, 2020, which claims priority to United Kingdom Patent Application No. 1910401.7, entitled SYSTEM FOR DISTRIBUTED DATA PROCESSING USING CLUSTERING, filed Jul. 19, 2019. The entireties if the aforementioned applications are incorporated by reference herein.

### BACKGROUND

Smart environments such as smart homes are characterised by a collection of interacting autonomous devices, including not just computing devices but also many other types of home appliances. Individual devices are typically low in computing capabilities but can communicate via wired or wireless networks and may interact directly and/or via a central control device such as a smart home hub. Architectures of many small/limited connected devices are also commonly referred to as the Internet-of-Things (IoT). In the example of a smart home, devices may include a range of devices providing useful functions in the home, for example network-connected appliances such as cooking or washing appliances, refrigerators, heating, ventilation and/or air conditioning (HVAC) systems, lighting appliances (e.g. networked light bulbs or light dimmers), locks etc. Other types of devices may be principally sensor devices (e.g. cameras, presence sensors, temperature sensors, smart meters e.g. for metering electricity, gas or other utility consumption). Some devices may combine both aspects (e.g. a smart speaker sensing sound and providing audio playback functions, a smart thermostat sensing environmental temperature and controlling a heating or air-conditioning system).

Taken together, such devices can produce substantial volumes of data. Efficiently processing this data, e.g. to optimise control strategies or the like, can be challenging, especially using the limited computing capabilities of such devices themselves or of hub or other control devices that may control the devices and collect data from them. For example, a heating system may be controlled by a smart thermostat based on instantaneous temperature readings, but the smart thermostat may typically not be capable of analysing larger sets of temperature data or other related data that might in principle be available.

### SUMMARY

Accordingly, embodiments of the invention seek to provide data processing architectures for analysis of data, in particular by data clustering that can be efficiently employed in smart environments to allow for improved control of devices in the environments. Embodiments also seek to provide improved data clustering techniques that can be applied in a variety of contexts.

In a first aspect, the invention provides a control system for a smart home environment comprising one or more devices connected to the control system via a communications network, the system comprising: means for receiving a plurality of data records from the one or more devices; means for transmitting data from the plurality of data records to a remote processing system for analysis; means for receiving cluster specification data from the remote processing system, the cluster specification defining a plurality of data clusters relating to the data records, the data clusters derived by the remote processing system at least in part based on the transmitted data; means for receiving one or more further data records from the one or more devices; means for classifying the one or more further data records by allocating the data records to one or more clusters of the data clusters based on the cluster specification data; and means for controlling at least one device in the smart home environment in dependence on the cluster allocation.

This approach can enable compute-intensive clustering to be offloaded to a remote server whilst still enabling the smart home controller to make control decisions based on the clustering results. Additionally, the remote system can additionally use data from other smart home environments in the clustering, to provide for more robust clustering and hence improved classification performance.

Although set out here in relation to a smart home environment, this and other aspects of the invention may be applied to any processing system involving an environment having one or more sensor devices, appliances, machines, or other devices communicating with a control device for the environment, which in turn can send data to the remote processing system via some network (e.g. the Internet). Such an environment may more generally be termed a “smart environment” and could comprise e.g. a commercial or industrial/manufacturing environment in addition to a home environment.

Note the term “data record” indicates a collection of related data elements without implying any specific data structure or representation. For example, a data record may comprise a row from a database table or view, having field values corresponding to columns of the row, a set of attributes of a data object, an XML or other markup-based textual data representation including data elements etc. Data records may also be referred to as data tuples or data vectors (the latter used typically in the context of clustering in a notional vector space defined by the fields/attributes of the data records being clustered). The terms “attribute”, “field”, “column” and the like are generally used interchangeably herein to denote constituent data elements of a data record.

Preferably, the devices include one or more energy consuming devices, and the received data records include energy consumption information relating to energy consumption by the one or more energy consuming devices in the environment. The devices may alternatively or additionally include one or more sensors, and the received data records may include sensor data from the one or more sensors. The data records preferably comprise information defining one or more of: a consumption quantity indicating an energy amount consumed by an energy consuming device; sensor data obtained by a sensor; time information indicating a time point or period for which the consumption quantity or sensor data was recorded.

The system may comprise means for sampling the received data records, preferably by selecting a subset of the data records, wherein the transmitting means transmits the sampled data records, preferably wherein sampling is performed using random gap sampling. This can reduce required bandwidth whilst also improving processing efficiency at the remote server.

The system may comprise means for grouping received data records into a series of time segments, and preferably performing subsampling for each time segment to select for each time segment a subset of the records of the time segment. A hash operation may be applied to data records, or to the sampled data records, of each time segment. The system may comprise means for compiling a data block from the received and/or sampled records, preferably from a predetermined sequence of time segments, the data block preferably comprising sampled and/or processed data records extending over a predetermined time duration; and the transmitting means transmits the data block. Thus, data may be transmitted in batches or bursts for processing at the remote system to reduce network load.

The classifying means is preferably configured to allocate a data record to a cluster by determining a closest or most similar cluster to the data record, preferably based on a predetermined distance or similarity measure. The terms “distance measure/metric” and “similarity measure/metric” refer to any measure that may indicate how close or alike two data records are to each other. The specific type of metric will depend on the data, but generally “similarity” may be considered the inverse of “distance” and so these terms are essentially used interchangeably herein.

The received cluster specification data preferably specifies representative data, optionally a centroid or medoid (or other representation of a cluster centre), for each of a plurality of clusters, preferably wherein cluster allocation is determined based on distance or similarity of a data record to respective representative data for respective clusters. The cluster specification data can thus essentially define a classifier which is generated at the remote server and used at the control system to classify data records.

The controlling means is preferably configured to control a device in the environment in dependence on a cluster membership identified for data from the device. The controlling means may be configured, in dependence on a cluster membership identified for data from a given energy consuming device, or another device or sensor, to control said given energy consuming device to alter operating behaviour and/or energy consumption of said device, optionally wherein the controlling means is configured to alter a control schedule or set point for an energy consuming device.

The invention also provides a data processing system configured to receive data from one or more smart home control systems as defined above or described elsewhere herein, perform a clustering operation on the received data to identify the plurality of data clusters, and transmit the cluster definition data to one or more of the smart home control systems.

In a further aspect (which may be combined with any other aspect set out herein), the invention provides a method of clustering data in a data set comprising a plurality of data records each having respective attribute values for a plurality of attributes, the method comprising: receiving clustering parameters comprising: a cluster count specifying a number of clusters to be generated; and a partitioning attribute, specifying a selection of a given attribute of the plurality of attributes of the data records; identifying a plurality of partitions of the data set based on values of the partitioning attribute; generating a plurality of initial cluster centres, each cluster centre defined for one of the partitions; running a clustering algorithm using the generated initial cluster centres to define starting clusters for the clustering algorithm, the clustering algorithm identifying a plurality of clusters based on the initial cluster centres; and outputting data defining the identified clusters.

The partitioning attribute may include categorical data, with the method comprising identifying a respective partition for each distinct category value in the partitioning attribute. Alternatively, a given partition could correspond to multiple distinct category values (i.e. category values need not map one-to-one to partitions). Alternatively, the partitioning attribute may include non-categorical data, the method comprising identifying a respective partition for each of a plurality of distinct categories derived from values in the partitioning attribute. For example, the method may comprise deriving a category for each of a set of distinct value sets or value ranges of a numerical (or other ordered) partitioning attribute.

Preferably, the method comprises allocating initial cluster centres to partitions in dependence on, optionally proportionally to, a number of data records in respective partitions. The method may comprise, where the number of partitions is less than the cluster count, allocating multiple initial cluster centres to one or more partitions, preferably one or more partitions with the most data records; and/or, where the number of partitions is greater than the cluster count, allocating a single initial cluster centre to each of a selected set of partitions, preferably those with the most data records.

Preferably, the method comprises allocating a plurality of initial cluster centres to a given partition by subpartitioning the given partition based on a second partitioning attribute, and allocating at least one initial cluster centre to one or more of the subpartitions.

Generating an initial cluster centre for a partition may comprise selecting an initial cluster centre randomly within a feature space defined by values of the data records in the partition, optionally by selecting a random record of the partition as basis for the initial cluster centre, or selecting the initial cluster centre from the records in the partition based on a density function.

The method may further comprise sampling the data set by selecting a subset of records from respective partitions and optionally subpartitions, wherein initial cluster centres for respective partitions are generated based on the selected records of the partitions.

Each initial cluster centre preferably comprises, or is defined by, a centroid or medoid.

A centroid may comprise (or otherwise indicate or specify) a centre for a cluster, e.g. in the form of a representative data record (or vector) defining a centre for a group of data records assigned to a cluster. Note that, unless required otherwise by context, the term “centroid” as used herein preferably refers to any form of data defining a cluster centre. This may be in the form of a vector in the clustering vector space which corresponds to a particular data record in the underlying data set or may be a vector in the clustering vector space that does not correspond to an existing data record (e.g. a mean vector computed from vectors in the cluster). Medoids (data vectors corresponding to existing records in the source data) or any other type of representative vector/record may be used in place of centroids and references to centroids, medoids and the like shall be construed accordingly. Cluster membership is generally determined by proximity/similarity of a data record to a cluster centroid, medoid or other representative vector.

The clustering algorithm preferably identifies the plurality of clusters by a process comprising: assigning data records to the starting clusters defined by the initial cluster centres, and re-computing initial cluster centres based on data records assigned to the corresponding clusters. The assigning and re-computing steps are preferably repeated until a termination criterion is met (where the assigning step uses the cluster centres computed in the previous iteration). For example, iteration may terminate when the assigning step no longer results in any changes in cluster membership.

In a further aspect of the invention (which may be combined with any other aspect set out herein), there is provided a method of clustering data in a data set comprising a plurality of data records each having respective attribute values for a plurality of attributes, the method comprising: receiving a partitioning attribute, specifying a selection of a given attribute of the plurality of attributes of the data records; identifying a plurality of partitions of the data set based on values of the partitioning attribute; sampling the data set by selecting a subset of records from respective partitions, wherein the number of records selected from a partition is dependent on the size of the partition, resulting in a sample set of records from the data set; running a clustering algorithm on the sample set of records, the clustering algorithm identifying a plurality of clusters based on the sample set; and outputting data defining the identified clusters.

The number of records selected from respective partitions is preferably further dependent on a total required sample size and/or the number of records selected from a partition may be proportional to the size of the partition, optionally in accordance with a required sampling ratio.

The method may comprise subpartitioning a given partition in dependence on at least one further partitioning attribute, and selecting sampled records for the given partition from respective subpartitions in dependence on the sizes of the subpartitions. Sampling may be performed using random gap sampling.

In a further aspect of the invention (which may be combined with any other aspect set out herein), there is provided a method of clustering data in a data set comprising a plurality of data records each having respective attribute values for a plurality of attributes, the method comprising: receiving a data type selection specifying one of a plurality of data types; deriving reduced feature vectors from data records of the data set, wherein a reduced feature vector comprises a set of attributes selected from the data records having the selected data type; running a clustering algorithm to identify a plurality of clusters in the data records, wherein the clustering algorithm clusters the derived reduced feature vectors to identify a plurality of data clusters; and outputting data defining the identified clusters.

The method may comprise repeating the clustering for each of the plurality of data types. The clustering is preferably performed in parallel for each of a plurality of data types. Each clustering pass may be performed using a different similarity or distance metric selected in dependence on the data type.

Clusters derived in this way based on reduced feature vectors (for a specific chosen data type) may then be used for classifying subsequent full data records, for example by classifying those data records using the corresponding reduced feature set used for learning the classifier.

In a further aspect of the invention (which may be combined with any other aspect set out herein), there is provided a method comprising: running a clustering process to identify a plurality of clusters in the data records at a first level of clustering; running a clustering process at one or more further levels of clustering, wherein the clustering process at a given further level identifies, for each of a plurality of higher-level clusters identified at a preceding level of clustering, a plurality of subclusters by clustering data records of the respective higher-level cluster; wherein clustering at each of the first and further levels of clustering is performed based on a clustering strategy selected from a plurality of available clustering strategies which is applied to records in the data set or in a cluster of records identified in a previous clustering level; and wherein the clustering strategy used at each level of clustering is configurable and specified by way of one or more clustering parameters.

Preferably, at least two clustering levels are performed based on different selected ones of the clustering strategies. The available clustering strategies may comprise one, several or each of: clustering data records based on initial clusters (e.g. cluster centroids) selected for a plurality of data partitions in accordance with one or more selected partitioning attributes, optionally using a method as set out above; clustering data records based on initial clusters identified by random centroid selection within the unpartitioned set of records to be clustered, optionally using k-means clustering; clustering data records based on reduced feature vectors selected in dependence on data types of attributes of the data records, optionally using a method as set out above.

The method may comprise, at a given clustering level, performing subclustering for a plurality of higher-level clusters in parallel. Clustering at one or more clustering levels may be performed on a reduced set of records obtained by sampling the data set or a higher level cluster, optionally using a method as set out above.

In a further aspect of the invention (which may be combined with any other aspect set out herein), there is provided a method of clustering data in a data set comprising data records, the method comprising: for each of a plurality of segments of the data set, each segment comprising a subset of records of the data set: retrieving a plurality of data records of the segment from storage; performing an initial clustering process on the retrieved data records to identify a set of clusters, each cluster defined by a representative data record; performing a further clustering process on the representative data records defining the clusters found for each segment to identify a second set of clusters; and outputting data defining the second set of clusters as a set of clusters for the data set.

The representative data records are preferably centroids or medoids of the clusters. Preferably, each segment is selected based on an amount of available memory of a processing system performing the method. Alternatively or additionally, each segment may be sized to fit in the available memory and/or to use no more than a predetermined amount of the available memory (e.g. a given proportion of available memory or an absolute memory quantity).

The initial clustering process and/or the further clustering process may be performed in accordance with any method as set out above. Retrieving data records for a segment may comprise sampling data records from the data set, optionally using a method as set out above.

The following features may apply to any of the above aspects. The method may comprise receiving one or more further data records and classifying the one or more further data records based on the cluster definition data output in the outputting step. The cluster definition data (as output in the outputting step) preferably comprises a cluster centre for each cluster, optionally a centroid or medoid (or other representative/central data record) for each cluster.

The data records may be received from one or more remote client systems, preferably at a central processing system performing the clustering, the method optionally further comprising controlling one or more client systems or devices connected thereto based on the identified clusters and/or based on classification of further data records using the identified clusters. Preferably, the outputting step comprises transmitting the cluster definition data to the client systems, and optionally using the cluster definition data at the client systems to classify subsequent data records and/or control one or more devices connected to the client systems, optionally wherein the client systems receive the data records from the one or more connected devices or generate the data records based on data received from the one or more connected devices.

In a further aspect, the invention provides a system having means, optionally in the form of one or more processors with associated memory, for performing any method as set out herein.

The invention further provides a system as set out in relation to the first aspect of the invention, additionally comprising the remote processing system, the remote processing system configured to perform clustering using any method as set out herein (e.g. as set out in relation to any of the preceding aspects of the invention).

The invention further provides a computer readable medium comprising software code adapted, when executed on one or more data processing devices, to perform any method as set out herein.

More generally, the described methods are preferably computer-implemented, using software running on one or more processing devices. However, features implemented in software may generally be implemented in hardware, and vice versa. Any reference to software and hardware features herein should be construed accordingly.

Any feature in one aspect of the invention may be applied to other aspects of the invention, in any appropriate combination. In particular, method aspects may be applied to apparatus and computer program aspects, and vice versa.

### DESCRIPTION OF THE DRAWINGS

Preferred features of the present invention will now be described, purely by way of example, with reference to the accompanying drawings, in which:

FIG. 1 illustrates a data processing system for processing data from multiple smart home environments;

FIG. 2 illustrates a data collection process;

FIG. 3A illustrates processing collected data using clustering;

FIG. 3B illustrates classification of new data based on the clustering;

FIG. 3C illustrates application of described techniques to energy usage monitoring and control;

FIGS. 4A and 4B illustrate partitioning of data sets;

FIG. 5 illustrates a process for allocating starting centroids for a clustering algorithm;

FIG. 6 illustrates multi-level clustering;

FIG. 7 shows an example of a data set clustered at multiple levels using different clustering approaches;

FIG. 8 illustrates clustering using parallel processing;

FIG. 9 illustrates an incremental clustering approach; and

FIG. 10 illustrates a processing device for performing described clustering algorithms.

### DETAILED DESCRIPTION

Embodiments of the invention provide a distributed data processing system which allows for data to be collected in one location and analysed, in particular using clustering, in a remote location. In a preferred embodiment, the system is applied within the context of IoT environments, and in particular smart home environments.

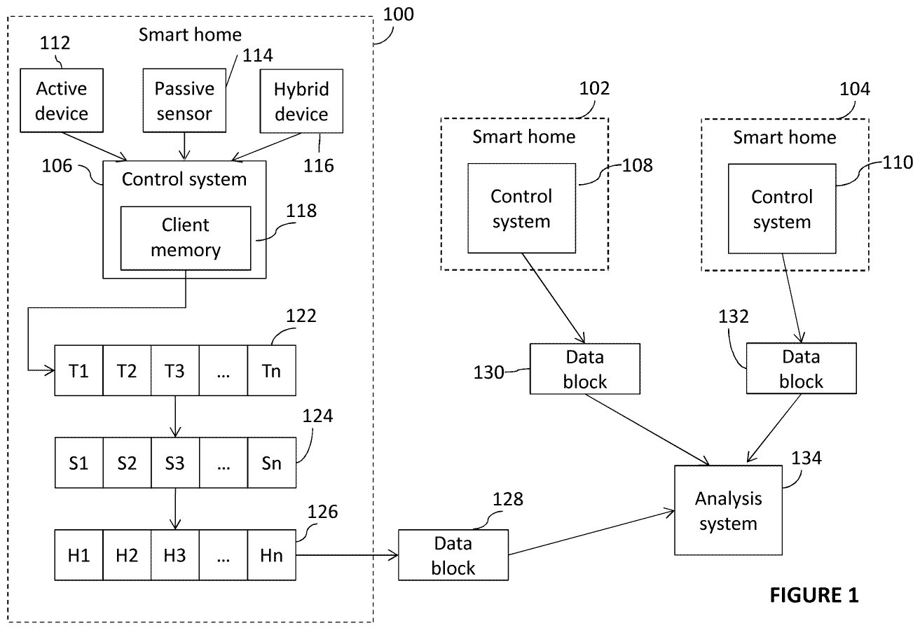

FIG. 1 illustrates a number of smart environments, in this case smart homes 100, 102, 104. A typical smart home 100 includes a number of local devices and sensors. By way of example FIG. 1 illustrates an active device 112 (that performs some useful function, e.g. heating or lighting), a passive sensor 114 (e.g. a temperature or light sensor) and a hybrid device 116 (including both active and sensing functions), but any number and/or types of devices may be present. A smart home control system 106, e.g. a smart home hub, controls and interacts with local devices, including receiving sensor data from passive sensors 114 and hybrid devices 116, and sending control data to (and possibly receiving control responses or status data from) active and hybrid devices 112, 116. The control system 106 (and similar control systems 108, 110 provided in other smart homes 102, 104) are connected to a remote analysis system 134 via appropriate network connections, for example via conventional wired and/or wireless home Internet connections, with the analysis system implemented at one or more remote Internet-connected servers.

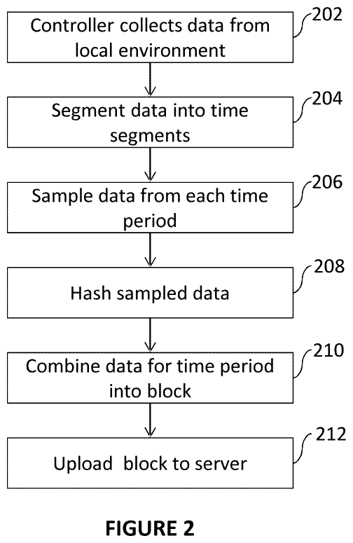

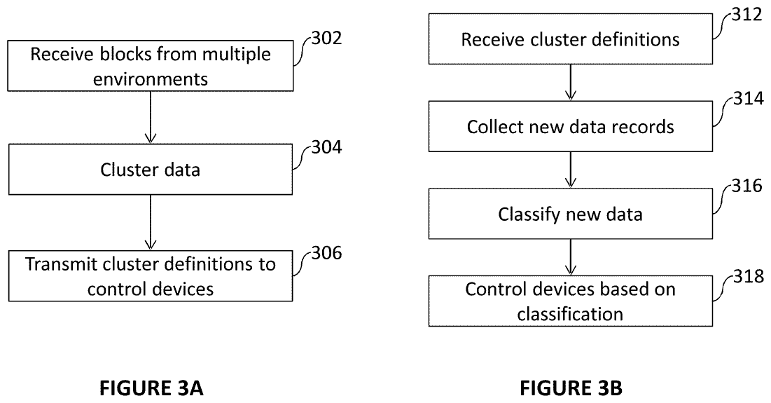

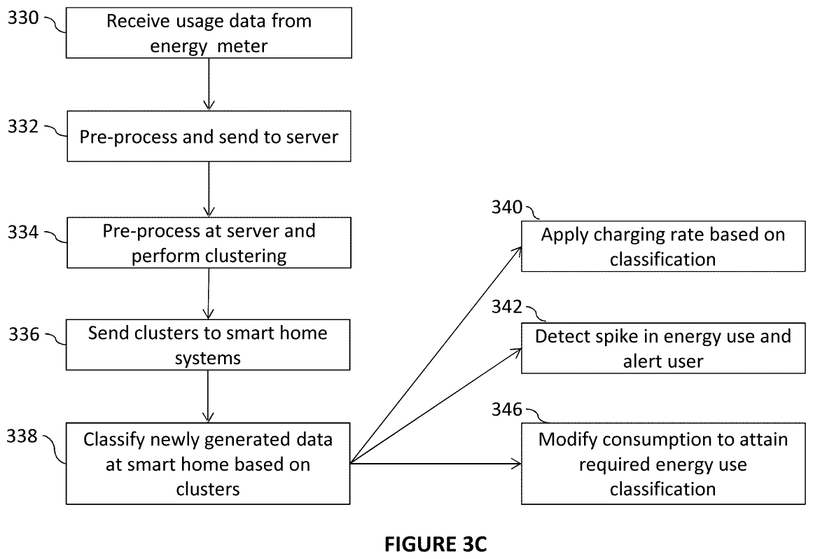

A process for collecting data, processing data, and using processing results in the control of smart homes is further illustrated in FIGS. 2, 3A and 3B, and is described below with continued reference to FIG. 1.

FIG. 2 illustrates steps performed at the smart home 100, e.g. by the control system 106. In step 202, the control system 106 collects data from the local environment, including any of device types 112, 114, 116. The data is temporarily stored in client memory 118, typically in the form of a set of data records, each including values for one or more data attributes. For example, a record for a sensor reading from a sensor could include a sensor identifier, a timestamp, and a sensed value (e.g. temperature value). A smart meter record could similarly include an identifier of the meter, a timestamp, an energy (or other utility) consumption value, and a period over which the consumption was measured. These are merely examples and the precise data will depend on various factors such as the type of the device and its function.

Furthermore, the control system (or another system component) may combine or augment data before further processing and forwarding the data. For example, a sensor reading could be augmented with location information specifying a location of the smart home. Thus the records ultimately processed by the clustering algorithm may be raw records as generated by devices or may have been pre-processed in various ways.

In step 204 the control system segments the data into time segments T1 . . . . Tn (122). In step 206 the system optionally samples the data by taking a selection of data from each segment. Sampling is performed if data volumes are too large for transmission and/or processing at the central analysis system. The data may be selected by any suitable sampling method. For example a gap sampling method may be used, allowing for continuous random selection of the data by use of a random gap between selected data points. Some possible sampling techniques are described in more detail below. Sampling results in a set of data samples S1-Sn (124), each including a subset of the data from a respective time segment T1-Tn.

In step 208, the sampled data for each segment may optionally be hashed to generate a unique identifier (or key) for each record and/or records may be timestamped, resulting in processed data segments H1-Hn (126) augmented with hash keys and/or timestamps. These steps can help to identify the data and make recombination easier.

The hashing is performed for each identified segment and reflects selected data in the time segment (for the whole period within the time segment, or a sample within the interval, obtained by a random or other sampling technique). Individual data values may be hashed. Alternatively, a time series of values may be hashed.

In step 210, data for a plurality of hashed segments H1-Hn corresponding to a given time period (e.g. 24 hrs) are combined into a data block 128, which is uploaded to the analysis system 134 in step 212. Note if the sampling and/or hashing steps are omitted then the data block is produced from the original or sampled records as appropriate.

FIG. 3A illustrates steps performed at the analysis system 134. In step 302, the analysis system receives a series of blocks from multiple smart homes (e.g. blocks 128, 130, 132). This may result in a large amount of data, which is stored in memory or persistent storage at the analysis system.

The analysis system then analyses the data by running a clustering algorithm on the data. The clustering clusters data records from the received data blocks to identify representative clusters of data records—i.e. groups of data records that are in some sense similar to each other. Any suitable clustering algorithms may be used. For example, techniques based on PAM (Partitioning Around Medoids) clustering, k-means clustering, k-means++ clustering etc. can be employed. Some specific examples of clustering algorithms that may be used to ensure that the data is selected and clustered representatively are described in more detail later.

The clustering process identifies multiple data clusters by assigning records to clusters based on a similarity metric (e.g. a Minkowski, Euclidean, Manhattan or other distance measure for numerical data). Clusters may be defined in any suitable manner. For example, each cluster may be defined by a representative value or vector defining a cluster centre. In clustering, the term vector refers to a set of values that correspond to attribute values of a data record. Thus, the terms “vector” and “data record” may be used interchangeably herein (though it should be noted that data vectors used in clustering may have been derived from underlying data records via pre-processing steps, e.g. to express data in a suitable format or select particular subsets of attributes on which clustering is performed).

The representative vector defining a given cluster may be in the form of a centroid (e.g. a data record comprising representative values, which need not correspond to values present in the data set, e.g. an average temperature value of temperature values in records assigned to a cluster), or a medoid (a given record taken from the records in the data set which defines a centre of the cluster, e.g. a record whose average dissimilarity to all other records in the cluster is minimal). Thus, in an example, the output of the clustering algorithm is a set of centroids defining centres for respective clusters.

The output of the clustering algorithm, specifically the cluster definitions (e.g. in the form of the centroids), are then transmitted back to the control system in each smart home in step 306. The cluster definitions, i.e. the centroids for each cluster, define a classifier that can be used for data classification at each smart home control system. Assuming that the sampling of data records at the smart home systems is representative, the resulting server-side clustering can be expected to create representative clusters.

The central analysis system may repeat the clustering after the next batch of data has been received from smart homes and may then transmit updated cluster definitions to the control systems. Clustering may be repeated at defined intervals or based on availability of data.

Further processing at the smart home control system 106 is illustrated in FIG. 3B. In step 312, cluster definitions are received from the central analysis system. Note that, compared to the source data itself, the cluster definition data is small (as it only requires the list of centroids or similar). This data can therefore be permanently stored in the client memory 118 at the control system 106.

However, because the cluster definitions are representative of the data collected from the smart home devices, they can be used on the client side to classify future data records. Thus, the smart home control system is able to perform real-time classification of received data records with only limited processing resources, but based on a broader collection of batch-processed data from multiple smart homes. Furthermore, by shifting the real-time classification to the client system, processing by the server can be reduced, whilst sampling at the smart home system reduces the need for transmitting large quantities of data through the network.

Thus, in step 314, the control system continues to collect new data records from local devices, sensors etc. These records are then classified based on the cluster definitions in step 316. This involves assigning each new record to a particular cluster based on content of the record and the defined clusters. Typically, a new record is assigned to a selected cluster having a centroid that is most similar to the new record, in accordance with the relevant similarity metric being used for clustering (e.g. Minkowski, Euclidean, Manhattan or other distance measure).

In step 318, the local control system then uses the classification results in making control decisions for the smart home environment, for example to control devices in the smart home environment, adjusting configuration of one or more devices to alter their operating behaviour etc.

For example, energy consuming devices such as heating systems may be controlled to alter their operation, switch modes and/or improve energy consumption efficiency (e.g. by altering a heating control schedule or operating set point, such as a target temperature).

A device may be controlled based on classification of data records produced by that device or one device may be controlled based on classification of data records produced by one or more other devices. More generally the described approach may be applied separately to data from individual devices, or clustering may take into account data from multiple devices and/or result in control actions relating to multiple devices.

In the above example, sampling is performed at the control system. However, alternatively or additionally, sampling could be performed at a device or sensor (112, 114, 116) generating the data, at the analysis system and/or at some other system component. Furthermore, in the FIG. 1 example, sampling is on a time segment basis with data subsequently combined into a block but alternatively, data could be sampled across a longer period e.g. a whole day and/or generation of a data sample could be triggered by an event, with data then sampled from a set of data preceding that event and formed into a block. The segmentation and processing of segments illustrated in FIG. 1 could be performed in a batch mode (e.g. with data for multiple segments processed in one pass) or segments could be formed, subsampled, hashed and combined into blocks on a segment-by-segment basis as the data is received at the control system. Transmission then occurs once sufficient data for a complete data block has accumulated.

The system architecture depicted in FIG. 1 is provided by way of example and modifications are possible. For example, devices 112-116 could perform some or all of the processing steps themselves. More generally the distribution of processing steps may be divided across system elements in a different manner, and this may differ between individual devices (e.g. a more capable device could process data and transmit data blocks without need for the control system).

However, in preferred embodiments, processing is arranged so that some sampling and/or other pre-processing is performed within or near the smart home 100, whilst the clustering is performed at a remote location, for data received from multiple smart home environments.

By pushing as much of the processing as possible onto the client side (smart home environment), network and central processing requirements can be reduced. In embodiments this is achieved by representatively sampling the data at each stage, so that a clustering system run on the server side creates representative clusters. These representative clusters can then be used at the client side for classification. As a result, the analysis system does not need to support real-time classification of incoming records (only batch analysis of received data blocks), reducing processing demands and data transmission across the network.

### Energy Management Applications

FIG. 3C illustrates a concrete application of the above approach to provide energy management functions to smart homes.

In step 330, the smart home control system receives energy usage data from an energy meter. In this example the control system could be in the form of a control hub or smart thermostat/HVAC controller, or the control functionality could be integrated into a smart meter. The data specifies energy usage as a time series of energy consumption values. The control system may additionally collect other data relating to the smart home (e.g. physical characteristic data such as size, location, or sensed data from around the home such as occupancy, light status, appliance usage etc.)

In step 332, the data is pre-processed and/or hashed (if needed) and sent to the analysis server. Data is collected into 24 hours blocks (or blocks of any other suitable time extent based on requirements) as described in relation to FIG. 1. Locality-Sensitive Hashing (LSH) may be employed. For example, sub-sequential time series clustering may be performed on the 24-hour data block using LSH. The sub-sequential time series clustering may be implemented as an initial clustering which may run in the each local smart home control system and may be helpful for segregating the disaggregated energy consumption and identifying the failure of an appliance in the home. This approach may also be used to dynamically partition the time blocks of consumption data into different consumption periods within the 24 hour period, e.g. peak consumption, low consumption, moderate consumption, etc.

The server performs the clustering as described elsewhere herein in step 334. Prior to clustering, the server may optionally perform pre-processing, e.g. to clean the data and/or augment the data with further information (for example based on location or time, or other auxiliary information held on the server relating to smart home location(s)). The clustering is configured to produce clusters which group similar users of energy. This could be done strictly on energy usage or using ancillary data, e.g. based on a combination of usage and location and/or weather data. The resulting clusters may thus define categories of energy usage behaviour observed at different smart homes.

In step 336, the cluster centroids are returned to the smart home control system and/or energy meter to allow processing at the smart home. The control system at the smart home then uses the defined clusters in step 338 to classify new data generated in the smart home system, and in particular new energy consumption data records generated by the energy meter. Based on classification of new data at the control system, the control system (and/or energy meter) may then perform a variety of actions, such as:
in step 340, applying different rates of energy charge depending on category of user (e.g. to reward lower usage in peak times); and/or
in step 342, indicating a spike in usage to a user (e.g. detected as a change of usage behaviour from a normal cluster to higher use cluster). A user could be alerted e.g. via a smart meter user interface, smartphone notification, SMS or other electronic message, etc. The indication could indicate a different usage change compared to similar customers; and/or
in step 344, interfacing with relevant system components in the home to maintain a given energy consumption category for the home according to the clusters (e.g. increasing energy usage when current usage is classified to a low-usage cluster, or reducing energy usage when in current usage is classified to a higher-usage cluster).

Other examples of how the cluster-based classification may be utilised could include:
giving a detailed breakdown of customer usage;
predicting and indicating the potential possible failure of customer's home appliances, boilers and the like,
providing usage reports e.g. via smart devices/mobile apps
provide suggestions and advice on consumption to customers; e.g. identifying if a particular smarthome is identified as a heavy consumer, providing recommendations regarding dynamic pricing and alternate energy usage times for specific appliances;
load shifting, e.g. controlling devices or prompting users to control devices to shift load away from peak load times,
preventing incidents/accidents/risks by regulating power supply to the appliances, boilers, car charging stations or the like

### Data Clustering Techniques

The following sections describe data clustering techniques that can be applied in the distributed data processing and clustering system as described above with respect to FIGS. 1-3. However, these techniques may also be applied in other contexts, including other processing architectures and types of data.

The techniques aim to allow for improved clustering on high dimensional data (where data is arranged in a fixed structure such as a table or combination of tables).

The following approaches are broadly based on k-means clustering and similar clustering approaches. Such approaches may typically start from a random selection of k centroids, where the centroids are random points in the vector space defined by the dimensions of the data.

Each data record, defining a set of attribute values corresponding to a feature vector in that vector space, is assigned to the nearest or most similar centroid, in accordance with the distance or similarity metric used to compare two feature vectors. For numerical values, Minkovski/Euclidean/Manhattan distance metrics may be used as the similarity/distance measure as discussed previously. For other (non-numerical) data types, any other suitable types of similarity/distance measures may be used, e.g. Hamming distance measures or probability/information theory/context-based similarity measures (concrete examples of similarity measures that could be used include Lin, Lin 1, overlap, Smirnov, Anderber, Goodall, (inverse) occurrence frequency (OF/IOF), Burnaby, Goodall4, etc.). Different distance measures (e.g. for different attribute values with different data types) may be combined, e.g. using a weighted sum or other appropriate computation, to define a distance measure for a complete feature vector including multiple attributes of different types.

The centroids are then recomputed as the centre of all data records assigned to the corresponding cluster (typically by computing the mean values for each attribute value, i.e. averaging the feature vectors, assuming the attributes are numerical, or identifying representative centre values for other data types e.g. based on the appropriate distance/similarity measure as discussed above). The process then repeats allocation of all records to the new centroids based on revised distances, and subsequent recomputation of the centroids, until the algorithm converges (no changes in cluster memberships) or until some other termination criterion is met (e.g. iteration count).

Data may be hashed before use to make data training easier and allow comparison between different data.

In these approaches, random selection of the initial points (centroids) means that the resulting clusters are not necessarily representative of the underlying data, and that clustering may not be reproducible.

The following techniques seek to address these and related problems.

### Selection of Initial Centroids Based on Underlying Data Dimensions.

A first approach is based on stratification of the data based on underlying data dimensions. In this approach the data is (notionally) partitioned into multiple partitions based on characteristics of individual records, and the centroids are initialized within those partitions.

For example, if an underlying dimension (i.e. a column in the table) is known to be of particular relevance to subsequent data processing (for example a column specifying a geographical location), the clustering algorithm is configured to select the initial centroids (to initialize the clusters) based on that particular dimension.

Partitioning is particularly effective when the underlying dimension is categorical (i.e. a data attribute having a plurality of predefined discrete data values, such as device type, geographical region etc.). Numerical data can be categorised if required, for example by dividing the numerical range of an attribute into distinct subranges, each corresponding to a category.

The approach may not work for some data types (for example text data), unless a categorisation can be applied to the data. Nevertheless, this approach can still work for mixed data where the dimension used for partitioning is categorical.

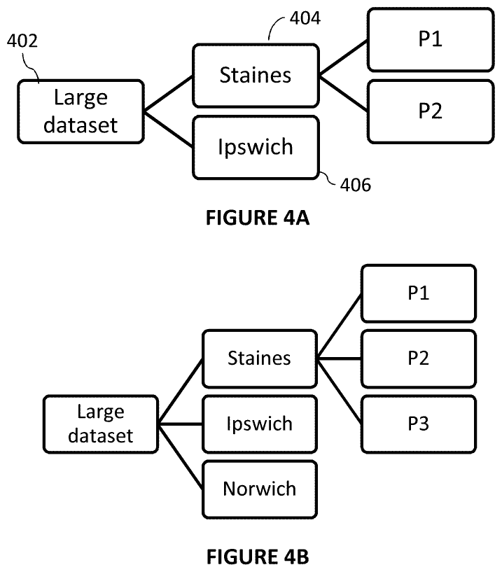

FIG. 4A illustrates partitioning of a large data set 402 into two partitions 404, 406 based on a data attribute indicative of a geographical location (e.g. town/city). Assuming two clusters are required, the clustering system is instructed to use the geographical location for partitioning. This results in two partitions of the data, with a single centroid initialized in each partition (one corresponding to the “Staines” region having all records with the location attribute set to “Staines” and one to the “Ipswich” region including all records with the location attribute set to “Ipswich”).

There could of course be any number of clusters and data partitions. The initial centroid is chosen randomly within each cluster, for example by selecting a random record in the partition as the initial centroid (or a random feature vector in a feature space defined by the values of data records in the partition). Alternatively, the initial centroid can be chosen based on a density function (selecting the most dense point location in the partition).

Note the number of clusters does not have to match the number of partitions. If fewer clusters are required than there are distinct categories in the attribute used for partitioning, then centroids are initialized in the largest partitions (i.e. those partitions containing the largest numbers of records). On the other hand, if more clusters are requested than supported by the available categories in the attribute used for partitioning (e.g. three clusters in the FIG. 4 example) then multiple centroids are initialised in the largest of the initial clusters (e.g. “Staines”), randomly or based on multiple high-density points.

In a further variation, one or more of the largest partitions may subdivided into subpartitions (e.g. P1, P2) using a further data dimension (e.g. another attribute) with separate clusters initialized in each subpartition. In this example, one centroid could be placed randomly in each of the “Ipswich” partition, the “P1” subpartition and the “P2” subpartition (for a total of three clusters). Any number of levels of subpartitioning can be applied, based on multiple selected partitioning attributes (typically this may depend on the volume of the data in the data set and/or respective partitions).

Generally, for larger numbers of clusters (relative to partitions), centroids may be initialised in proportion to the size of the partition, such that larger partitions receive more clusters (e.g. in the FIG. 4A example cluster centroids could be distributed between the “Staines” and “Ipswich” partitions at a ratio of 70:30 where 70% of the records in the dataset have the value “Staines” in the partitioning attribute).

The choice of partitioning dimension is user-configurable. By initializing the clustering algorithm based on a dimension of interest, the quality and/repeatability of the clustering can be improved.

Once the partitioning has been performed cluster initialization can follow any suitable clustering techniques (including known PAM/k-means/k-modes clustering techniques). In an embodiment a density-based estimator is used, but simple random selection is also possible.

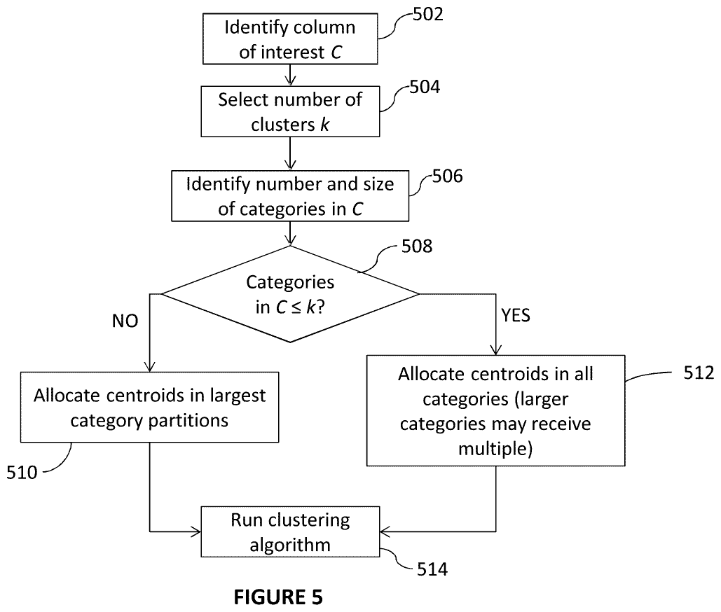

The process is summarised in FIG. 5. In step 502, the column of interest C in the data set is identified. In step 504 the number of clusters k is selected. The column of interest C and cluster count k may be configured by user selection (e.g. via a user interface), via parameter in an API invocation, or in any other appropriate way. In step 506, the number of partitions (distinct category values of the selected column) and the size of each data partition (i.e. subset of data records associated with a respective category value for the selected column) is determined. For example, an SQL or similar query is run to identify record counts for each distinct column value.

In step 508, the process determines whether the number of categories in the column is less than or equal to the required cluster count k. If not (there are more categories than clusters), then in step 510 a centroid is allocated in each of the k largest category partitions. If yes, then in step 512, centroids are allocated in every category partition, with larger partitions being allocated multiple centroids where the number of clusters exceeds the number of categories.

In either case, the clustering algorithm is then run in step 514 based on the previously configured starting centroids.

### Data Sampling

For large datasets it may not be possible to use the entire data set (for example due to memory limitations). In this case a selection of the data can be used to perform the clustering and build the classifier. By careful sampling of the large dataset it is possible to ensure that the selection used is representative, so that the clustering is repeatable/scalable.

Conventional systems typically take a random selection of data (e.g. 10% of the data set). However, with that approach, the only way to ensure representative sampling is by taking a sufficiently large sample.

The approach described here therefore bases the sampling on representative data, and if necessary can use multiple sampling stages to ensure this holds true. Sampling is based on partitioning of the data, as described above in relation to partition-based clustering.

The process starts with identifying (e.g. by user input) the dimensions for each partitioning stage (e.g. which attributes of the data set should be used for partitioning and hence will provide the basis for ensuring the sampled data is representative).

The sampling first chooses records based on the first dimension (partitioning attribute). Note partitioning of the data set based on partitioning attributes is performed as described above. Records are selected from partitions in proportion to the size of each partition, typically defined by the number of records in each partition, in accordance with an overall required sampling ratio. For example, in the FIG. 4B example, assuming records are distributed across the “Staines”, “Ipswich” and “Norwich” partitions (partitioned based on a geographical attribute with 70, 20, and 10 records respectively in each partition), and the sampling ratio is 10% (10% of records are to be sampled), then 7, 2 and 1 record are respectively sampled from each partition.

For large data sets multi-stage partitioning can be used to improve representativeness. For example, the “Staines” partition (70 records) may be further divided (where additional values are needed) into partitions P1, P2, P3 (based on a second partitioning attribute), with sampling within those subpartitions (to select the required number of records for the partition) again proportional to the number of records in each subpartition (thus the total number of records to be sampled from the partition is divided across the subpartitions proportionally to their respective sizes). Any number of levels of subpartitioning can be applied, typically depending on the data volumes.

The record selection process continues until the required sample size of data has been chosen. At that point the sample can be assumed to be representative (in terms of the partitioning attributes chosen). Clustering is then performed (using conventional techniques or those described herein) based on the final data sample. Because the sampling was representative, this should generally also mean that the clusters derived from the sampled data should be representative of the whole data set.

When sampling inside each of these partitions/subpartitions, a number of sampling techniques may be used—for example, reservoir sampling, gap sampling, cluster sampling etc. Additional examples of suitable sampling techniques are given in the section below headed “Data sampling techniques”. In preferred embodiments, random gap sampling (or a related technique) is used as this can allow efficiency improvements because the size of the data does not need to be known.

By sampling the dataset in relation to the size of the categories of interest the clustering is more repeatable and is encouraged to follow the representation of the categories of interest, especially when combined with the previously described partition-based clustering. When used in combination, the same partitioning attributes are typically used for sampling and centroid selection, to constrain or bias the clustering algorithm based on the desired data dimensions. However, there may be cases where this is not the case. For example, sampling could use more partitioning layers than cluster initialization (or vice versa).

### Phase-Based Clustering

Instead of partition-based clustering, clustering may also be performed based on data types of attributes within the data records. This may be useful given that different clustering strategies (based on different distance/similarity metrics) may be applicable to different data types. This is referred to herein as phase-based clustering, where each “phase” corresponds to a view on the data set that is limited to a specific data type.

The following example assumes three fundamental data types (though the specific types can be adapted to the available data): numerical data, categorical data, and text data.

Phase-based clustering selects a subset of the attributes of the data records that have a specified data type. For example, for data records having 100 attributes (corresponding to features in the clustering feature space) which are divided into 10 numeric, 30 categorical and 60 text attributes, clustering may be performed using only the 10 numeric fields. A separate clustering may be performed using only the 30 categorical attributes, and yet another based on the 60 text attributes. This results in three separate clustering results, each defining a different group of clusters (and hence a different classifier) for the same underlying data set and so providing a different view of the underlying data. More generally such a phase-based clustering may be performed for any available data type and may be repeated for every such data type or only for selected data types.

The clustering itself is performed using any technique as described herein or a conventional clustering technique, except that the feature space, and hence the features defining feature vectors for each data record, are restricted to the data attributes of the specified type (e.g. numerical). In other words, the clustering is based on reduced feature vectors including only those attributes that correspond to the selected data type. Furthermore, clustering may then be adapted to use techniques appropriate to that type (in particular similarity/distance measures, e.g. using a Minkowski/Euclidean/Manhattan distance measure for numerical data and a hamming distance or any other probability/information theory/context-based measures such as Goodall, Lin, Lin1, Smirnov, OF/IOF etc. for categorical or text data).

Data of relevant attributes may be explicitly extracted from the underlying records to form the feature vectors used for clustering, but for efficiency the relevant attribute values are preferably dynamically accessed from the underlying records (e.g. using a view).

Multiple-phase based clustering passes for different data types may be run in parallel.

In a further variation, a phase-based clustering could use only selected attributes of the given data type (selected by a user) rather than all attributes of that type.

### Hybrid Multi-Stage Clustering

In this approach, clustering is performed iteratively, with clusters identified in one iteration subdivided into subclusters in a following iteration. At each iteration, clusters are initialized based on partitions, as described above. The list of partitioning attributes for each clustering stage may be specified in advance, or alternatively, a selection of partitioning dimension can be made at each iteration to guide the next stage of clustering.

This approach can be implemented in a parallelised fashion. Specifically, after an initial set of clusters has been determined, the clusters can be processed in parallel to derive a group of subclusters for each higher-level cluster. Any number of clustering stages may be implemented.

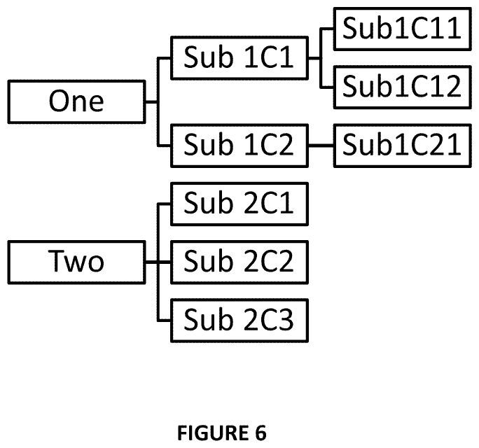

FIG. 6 illustrates an example with three stages. Here two high-level clusters “One” and “Two” are formed in the initial pass. In a second pass, cluster “One” is divided into “Sub1C1” and “Sub1C2”, and (possibly in parallel) cluster “Two” is divided into “Sub2C1” to “Sub2C3” based on the selection of a dimension (column) either at the start, or after generation of clusters “One” and “Two”. A third stage for further subdividing the subclusters of cluster “One” is also shown.

Each clustering at each stage may be performed using the partition-based clustering described above. Alternatively, partition-based clustering may be used in some stages but not others. For example, the initial stage (e.g. to generate clusters “One” and “Two”) may be partition-based, with the subclusters at subsequent levels generated conventionally. Regardless of the clustering approach, the representative sampling method described above can also be used (e.g. for large data volumes) to ensure that the clusters at each level remain representative.

In the multi-stage clustering approach, partition-based, phase-based based and ordinary (unconstrained) clustering (e.g. with random centroid selection without partitioning) may be combined in any required manner. In such a hybrid approach, the clustering levels may have different clustering types, including:
Partitioning layer levels—data subsets selected based on categories of (or derived for) selected data attributes
Phase-based levels—clustering based on data types
Ordinary levels—Ordinary unconstrained sub-clustering inside other clusters.

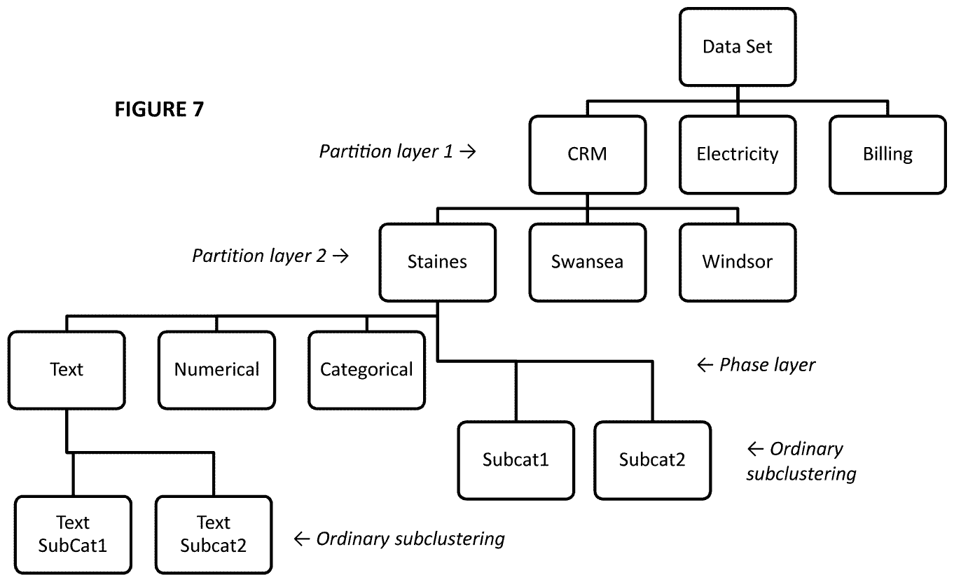

An example use case is illustrated in FIG. 7. Here it is assumed that the process starts with clustering based on different partitions (corresponding to selected dimensions/table columns) within the global data set, represented by the “partition layers”. This initial clustering allows the user to move between partitions to see different clustered aspects of the data. However, the user may also want to see how different types of data are affected (by viewing the different phases of data, creating new clusters within a partition—see “phase layer”), or by looking at sublevels within clusters—i.e. nested clusters which are not dependent on partitioning or phase (labelled “ordinary subclustering”). Different phase-based and ordinary clustering levels may be generated concurrently based on the output of an earlier stage (or set of earlier stages).

In each case, subclusters are generated by clustering only those data records within the higher cluster being processed (or within the whole data set in the case of the first level of clustering).

Note that FIG. 7 is merely an example, and the precise arrangement of clustering levels, partitions etc. will vary depending on the data at hand and the goals for the analysis.

The clustering strategy used at each clustering level is configurable, e.g. by a user or other system by way of clustering parameters, which may be specified via a user interface or API parameters or the like. The clustering strategies may be specified in advance for all levels, or level by level, e.g. in a step-by-step interactive process based on inspection of the results of the preceding level.

This approach can enable flexible clustering for big data sets with different types of clustering applied in various combinations. This in turn allows a user to generate multiple breakdowns of data to allow efficient analysis. Furthermore, parallelisation can be employed to perform clustering efficiently.

### Multi-Stage/Multi-Level Clustering at Scale

The above section describes efficiency improvements through parallelisation of clustering stages. Further efficiency gains can be achieved by constraining the stages. Specifically, the process involves fixing the order in which types of clustering are applied.

In the FIG. 7 example, partition-based clustering is performed first, followed by phase-based clustering.

Thus, in a first stage one or more levels of partition-based clustering are performed. At each level, individual clusters can be split out across separate machines to perform subclustering. After each level is complete the controller must then make a comparison between the complete levels and correct/iterate any differences.

In a second stage, once the partition-based clustering is complete, a further breakdown can be made—for example, for each phase (data type) inside each level.

Again, each phase is separated so that separate machines execute the clustering algorithm for each phase. Inside each phase a further breakdown into clusters can be performed, with a machine assigned to each cluster inside the phase clusters.

Once each machine finishes processing it then reports up to the master/stage above.

Thus in each case, where multiple instances of the clustering algorithm are run at the same stage these can be run at the same time in parallel.

In preferred embodiments, the data is representatively sampled using the sampling techniques described previously, either initially (at the top level) and/or at any subsequent clustering level to improve the representativeness of resulting clusters.

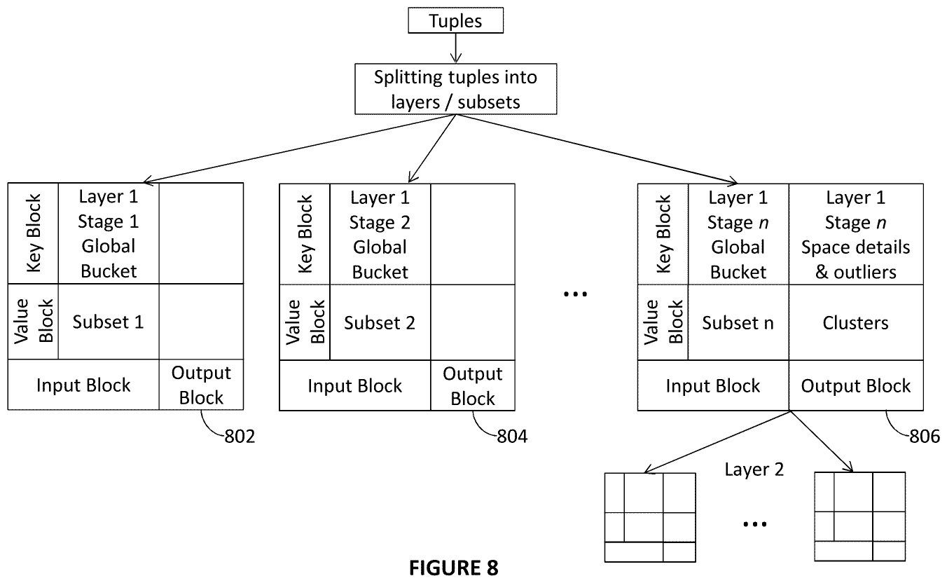

Parallelisation of the multi-stage process is illustrated in more detail in FIG. 8, showing the division into chunks suitable for parallel processing. At each stage, global levels in each partition layer will run in parallel. Similarly, local levels in each stage are run in parallel. In case of a bottom to top approach, at each stage local levels in each layer will run in parallel first and once these processes complete, then each stage at the global level runs in parallel by using the local level results. In case of a top to bottom approach, each stage at the global level runs in parallel and once these processes complete then the local levels of each stages are trigged to run in parallel.

Initially, each layer's tuples are divided into multiple subsets/sub-tuples based on the number of stages in each layer. At each stage sub-tuples in each layer are stored into multiple global level buckets. Then these global level buckets are distributed for parallel computing to compute the global level processes. In order to map them back, key and value blocks are used for both input blocks and output blocks. Input blocks handle the input tuples details and output blocks handles the results of clusters after computation.

In the FIG. 8 example, data blocks 804-806 represent individual blocks of data which may be processed in parallel e.g. by different processing cores or different devices. The blocks are dived into Input Blocks and Output Blocks, which are further subdivided as follows:
“Input key block”: holds the unique information about the nodes and related processing devices and also the unique input dataset IDs identifying the processed data records.
“Output key block”: holds the unique information about the nodes and related processing devices and also the unique ID information about the processed/computed dataset.
“Input value block”: holds the real input values or data in those nodes/processing devices before computing.
“Output value block”: holds the real output values or data in those nodes/processing devices after computing.

### Incremental Clustering

In the above approaches, sampling may be used to allow clustering for large data sets, where the entire data set would be too large to process efficiently. The data set itself is generally stored on persistent storage (e.g. magnetic disk drives) on one or more data storage devices but it may typically be preferable to be able to hold the dataset—or a sample of it—in main memory to allow the clustering algorithm to run efficiently.

However, in some cases even a sample of the data (of reasonable size) may be too large to hold in memory.

Therefore, in an embodiment the system clusters segments of the data set separately and then processes the resulting clusters to determine final clusters.

The system starts by loading a data segment comprising a set of records (e.g. a percentage of the data set) and runs a clustering algorithm on this segment to produce a set of clusters. This process is repeated for further segments of the data set (each segment selected to be of an allowable size, e.g. based on available memory so that the entire segment can fit into memory). The segment may optionally be sampled from the underlying data set using the sampling approach described previously. Once a sufficient sample of data (or possibly all available data) has been processed and formed into clusters, the cluster definitions of the clusters (typically in the form of the centroids resulting from each clustering run) are used as inputs to a further clustering run. At this stage, it is the centroids themselves that are clustered rather than the underlying data. This results in a final set of clusters (defined by a new set of centroids).

At each stage the selection of data is preferably representative (e.g. following the representative sampling method previously described) to ensure that the final clustering is effective. The clustering at either stage may use any appropriate clustering algorithm, including those described herein.

This approach reduces memory requirements since initial clusters are built from individual data segments, with the final stage generating the final clusters from the cluster centroids of the initial clustering (essentially as clusters of clusters). Individual data records can then be classified against these final clusters as normal.

Furthermore, in this approach individual data segments can be processed in parallel to improve efficiency.

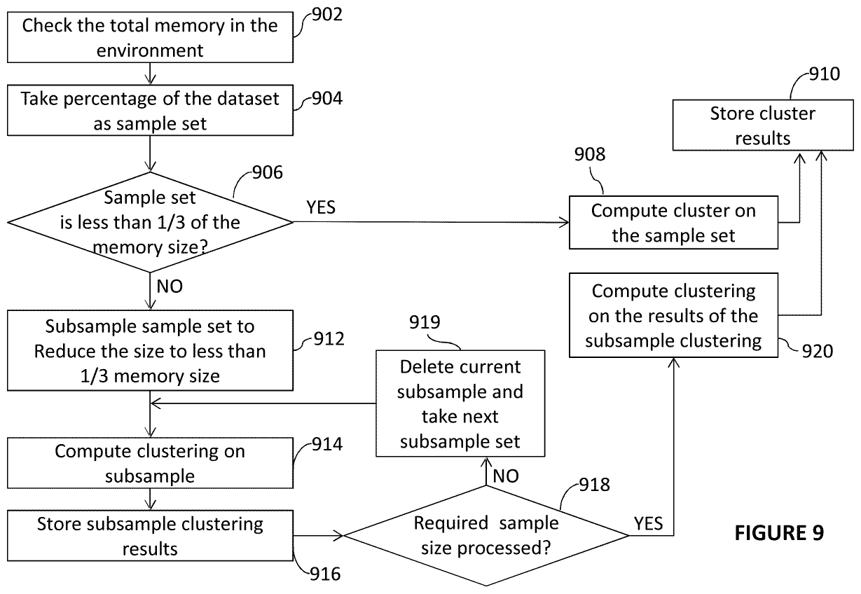

An example process implementing this approach is summarised in FIG. 9. In step 902 the process checks the available memory in the processing environment (or specifically the amount of memory available to the clustering process). “Memory” here refers to RAM (random access memory), i.e. fast, volatile semiconductor memory rather than slower, persistent storage (e.g. disk storage). In step 904, the process identifies a sample of the data set to be clustered. This may be a predetermined quantity of data, e.g. 15% or some other predetermined percentage of the original data set. The quantity may be chosen to allow for representative sampling. In step 906 the process determines whether the identified sample meets a memory threshold. In this example, the threshold test is whether the selected sample would occupy less than ⅓ of the available memory size. In practice, the threshold is selected to allow sufficient headroom for processing operations, intermediate and final results etc. whilst ensuring that the entire sample can be kept in memory during processing. If the sample meets the threshold test, then the process computes the clustering on the sample set in step 908 and stores the resulting cluster definitions in step 910.

If the selected sample does not fit in the allowed memory space (i.e. it does not meet the memory threshold of step 906), then the described multi-stage clustering is applied. Specifically, the previously identified sample is subsampled in step 912, to obtain a subsample that does meet the memory threshold (in this case occupying less than ⅓ of the available memory size). Clustering is then performed on the subsample in step 914. In step 916 the resulting cluster definitions are stored as intermediate results.

The subsampling/clustering is repeated in a loop, and so in step 918, the process determines whether the required sample size (e.g. 15% of total data volume) has been processed. If the required sample size has not been reached, then the process discards the current subsample from memory, obtains a further subsample of the initial sample (step 919) and repeats the clustering (step 914) and storage of results (step 916). Once it is determined in step 918 that the required sample size has been reached, the process proceeds to a second level clustering in step 920. In this step, the results of the subsample clustering iterations (computed in step 914 and stored in step 916) are processed in a further clustering operation, this time operating on the cluster centroids output in the earlier iterations, to produce the final set of clusters. The cluster definitions (centroids) are then stored as the final clustering output in step 910.

This approach is therefore able to adapt the clustering approach dynamically to the amount of data being processed and the available memory in the processing environment to improve processing efficiency by avoiding disk access during clustering.

### Distributed Incremental Clustering

In a distributed processing environment such as the FIG. 1 example, incremental clustering may involve processing at different devices throughout the network. For example, while the central analysis server may be considered a “cloud” device, other devices located between the smart home control system and the central analysis server may also be involved in data processing. Such devices may be termed “mist devices” or “fog devices”. The smart home control system itself may be termed an “edge device”.

In such an arrangement, data from the smart home control system may be sent to fog and mist devices in addition to the cloud server. Additional processing and clustering may be performed at those intermediate devices. Typically, for ‘n’ number of edge devices there will be ‘m’ number of fog devices and then ‘p’ number of mist devices and finally ‘q’ server devices (e.g. there could be 100000 edge devices served by 1000 fog devices, and for every 1000 fog devices there might be around 80 mist devices and then the 80 mist devices are in turn supported by a small number of central servers or even a single central server).

In this approach, the data collected from ‘n’ smart meters is sent to the server and in parallel it also send to fog devices. For example, a fog device may serve one particular district, with the data from a number of smart home controllers in that district being sent to that particular fog device. These fog devices are used to run the machine learning models (i.e. clustering) and send the results (i.e centroids and other information) back to all edge devices in that district to classify the new data generated in those edge devices to find anomalies etc. In parallel these results are also sent to the mist device in that postal area and also to the central server(s).

The results from a number of such fog devices are sent to the related mist device in that postal area. The results from fog devices are used as input to run machine learning models (i.e clustering) in the mist device located in each postal area. These results (i.e centroids, plus additional information such as identifying the mist device, mist device location information, etc.) are sent to the central server, fog devices and edge devices in parallel. The edge devices can again utilise the results to classify the new data generated in the smart homes.

The central server(s) receive the raw data generated from smart homes, plus the results from the intermediate fog and mist devices. The server(s) may optionally add further information (e.g. based on location or timing, or other auxiliary information held on the server relating to smart home location(s)). The central server then uses these results to compute the global level clustering. The final cluster centroids are then returned to the edge devices (smart home controllers) to allow processing and classification as previously described. Additionally, the cluster centroids can be returned to the fog and mist devices.

In this approach clustering may thus be performed hierarchically for various geographic regions supported by intermediate network nodes, in addition to the global clustering performed at the central server. Edge devices may make use of cluster results from any of the intermediate devices or central servers as appropriate to perform classification of new data.

### Data Sampling Techniques

In the approaches described herein, sampling may be used to reduce the amount of data to be processed. With reference to FIG. 1, sampling may occur, e.g., at a device generating data (e.g. a sensor device or other device 112-116), at a smart home control system 106-110, or at the analysis system 134 prior to or during analysis. In each case, conventional sampling techniques may be used, such as random gap sampling. Alternatively, the following techniques may be employed.

A first technique is referred to as “StrataGap Sampling”. In this approach, the dataset is divided into relatively homogenous isolated strata and then locality-sensitive hashing (LSH) is applied to bucket the data points of similar strata objects into the same buckets. The samples are then picked from these isolated homogenous buckets by using the gapping technique.

A second technique is referred to as “ClusterGap Sampling”. In this approach, the dataset or population is divided into relatively homogenous isolated strata and then locality-sensitive hashing (LSH) is applied to bucket the data points of similar strata objects into the same buckets. Subsequently, certain whole buckets of data points are selected using the gapping technique. The entire contents of the selected buckets then form the output sample.

These techniques can be used to obtain representative samples with increased performance where the input data set is large. These sampling techniques could be applied in single stage or multi-stage as follows:
Single stage StrataGap sampling
Multi stage StrataGap sampling
Single stage ClusterGap Sampling
Multi-Stage ClusterGap sampling

### Detailed Algorithm Example

The following provides a more detailed description of an example implementation of a clustering algorithm, which may be suitable for implementing the “hybrid multi-stage clustering” approach described above. However, it should be noted that this is merely an example of how such an algorithm may be implemented and other implementations are possible. Any suggestion or implication in the following description that particular algorithm features are important or even essential pertain only to this specific implementation example and not to the broader principles of the algorithms set out previously.

### Algorithm Example: Flexible Milky Way Clustering for Bigdata—Multi-Layer/Multi-Phase/Multi-Level

Suppose we have a Tuple T= [symbol] D₁^{f}, A₁^{f}, R₁^{f}, Ø₁^{f} [symbol] , [symbol] D₂^{f}, A₂^{f}, R₂^{f}, Ø₂^{f} [symbol] , . . . , [symbol] Dₜ^{f}, Aₜ^{f}, Rₜ^{f}, Øₜ^{f} [symbol] .
Dₜ^{f}: is the collection of datasets in t^{th} tuple f type dataset

$${𝒟}_{t}^{f} = \{ {x}_{t , 1 , i , 1}^{f} , {x}_{t , 1 , i , 2}^{f} , … . , {x}_{t , 1 , i , m}^{f} \} , \{ {x}_{t , 2 , i , 1}^{f} , {x}_{t , 2 , i , 2}^{f} , … . , {x}_{t , 2 , i , m}^{f} \} , … … , \{ {x}_{t , d , i , 1}^{f} , {x}_{t , d , i , 2}^{f} , … . , {x}_{t , d , i , m}^{f} \}$$

$${𝒟}_{t}^{f} = {\{ {𝒟}_{t , d}^{f} \}}_{l = 1}^{d} = \{ {𝒟}_{t , 1}^{f} , {𝒟}_{t , 1}^{f} , … … .. , {𝒟}_{t , d}^{f} \}$$

D_{t,d}^{f}: is the dataset in d^{th} subset t^{th} tuple datasets f type dataset

$${D}_{t , d}^{f} = {\{ {X}_{t , d , n}^{f} \}}_{i = 1}^{n} = \{ {X}_{t , d , 1}^{f} , {X}_{t , d , 2}^{f} , … … , {X}_{t , d , n}^{f} \}$$

D_{t,d}^{f}=[x_{t,d,n,m}^{f}]_{i=1,j=1} n,m is a n-by-m design matrix in t^{th} tuple f type dataset of d'th subset.

Each instance or object X_{t,d,i}^{f}={x_{t,d,i,m}^{f}}ⱼ₌₁^{m}={x_{t,d,i,1}^{f}, x_{t,d,i,2}^{f}, . . . , x_{t,d,i,m}^{f}} in d^{th} subset t^{th} tuple datasets f type dataset is characterized by a set of m dimensions or features or attributes.

The features or attributes or instances A_{t,d}^{f,q} with q datatype in d^{th} subset t^{th} tuple f type dataset
A_{t,d}^{f,q}={a_{t,1,1,j}^{f,q}, a_{t,1,2,j}^{f,q} . . . , a_{t,1,n,j}^{f,q}}, {a_{t,2,1,j}^{f,q}, a_{t,2,2,j}^{f,q}, . . . , a_{t,2,n,j}^{f,q}} . . . , {a_{t,d,1,j}^{f,q}, . . . , a_{t,d,n,j}^{f,q}} A_{t,d}^{f}=[A_{t,d,i,m}^{f,q}]_{r=1,j=1}^{q,m} is a q-by-m features or attributes or instance or object matrix in d^{th} subset t^{th} tuple f type dataset.

Dₜ^{f}: is collection of datasets i.e t^{th} tuple f type dataset, D_{t,d}^{f}: is d^{th} subset t^{th} tuple datasets f type dataset, X_{t,d,n}^{f} is a set of n objects or instances or observations d^{th} subset t^{th} tuple f type dataset,
X_{t,d,i,m}^{f}: is a set of i^{th} object in d^{th} subset t^{th} tuple f type dataset with m number of features or attributes,
T: set of tuples, X_{n,m} is a design matrix store n^{th} object or instances or observation and m number of attributes, A_{t,d}^{f}: is the attributes in d^{th} subset t^{th} tuple datasets f type dataset, a_{t,d,i,m}^{f,q}: is the attributes

Our goal is to partition the given tuple into some multi-layer/multi-phase/multi-level clusters:

The clustering procedure results from a mathematical problem

$$\{ {C}_{1 , 1 , f}^{{l}_{a} , {l}_{e}} , {C}_{2 , 1 , f}^{{l}_{a} , {l}_{e}} , … … … , {C}_{k , 1 , f}^{{l}_{a} , {l}_{e}} \} , \{ {C}_{1 , 2 , f}^{{l}_{a} , {l}_{e}} , {C}_{2 , 2 , f}^{{l}_{a} , {l}_{e}} , … … … , {C}_{k , 2 , f}^{{l}_{a} , {l}_{e}} \} , … … , \{ {C}_{1 , p , f}^{{l}_{a} , {l}_{e}} , {C}_{2 , p , f}^{{l}_{a} , {l}_{e}} , … … … , {C}_{k , p , f}^{{l}_{a} , {l}_{e}} \}$$

denotes sets containing the indices of the observations in each phase clusters on lₐ layer in lₑ level. These sets satisfy the following properties:
C_{1,p,f}^{l}^{ₐ}^{,l}^{ₑ}∪C_{2,p,f}^{l}^{ₐ}^{,l}^{ₑ}∪C_{3,p,f}^{l}^{ₐ}^{,l}^{ₑ} . . . ∪C_{k,p,f}^{l}^{ₐ}^{,l}^{ₑ}={X_{t,d,n}^{f}}ᵢ₌₁ⁿ. In other words, each observation n in lₐ th layer in lₑ th level and in p th phase is belonging to at least in one of the K clusters.
C_{l,p,f}^{l}^{ₐ}^{,l}^{ₑ}∩C_{k′,p,f}^{l}^{ₐ}^{,l}^{ₑ}≠Ø for all k=k′. In other words, the clusters are non-overlapping or distinct in the case of non-overlapping or nonfuzzy clustering. No observations belong to more than one clusters.
C_{k,p,f}^{l}^{ₐ}^{,l}^{ₑ}∩C_{k′,p,f}^{l}^{ₐ}^{,l}^{ₑ}Ø for all k=k′. In other words, the clusters are overlapping or non-distinct in the case of overlapping or fuzzy clustering. No observations belong to more than one clusters.
For instance, if the i^{th} observation in lₐ^{th} layer in lₑ^{th} level and in p^{th} phase is in the k^{th} cluster, then i∈C_{k,p,f}^{l}^{ₐ}^{,l}^{ₑ}. The idea behind multi-layer-multiphase-multilevel clustering is that a good clustering is one for which the within-cluster variation is as small as possible.
   Where, lₐ: number of layer, lₑ: number of level, p: number of phase, f: dataset at rest or finite dataset or streaming dataset, k: number of clusters, C: represents cluster.

For example the set of data instances or objects in d^{th} subset t^{th} tuple datasets f type dataset X_{t,d,i,j}^{f}∈R^{m}, i=1, 2, . . . , n, the algorithm aims to find a global partition represented as bigdata flexible milky way clusters, while minimizing the cost function F by adopting the distance method, which is defined as the sum of the squared distances the data points and the corresponding centres. This can be proposed as shown below:

### Start:

STEP1: Pre-process the Tuple T and store it in data lake by restructuring the Tuple T in the optimized multistage way of data structure using indexing, vectorizing, bucketing and partitioning to bringing the sample dataset or full dataset {x_{t,d,i,m}^{d}}ⱼ₌₁^{m} from Tuple T in case of f=finite dataset or data at rest.

STEP2: The lattice Locality sensitive hashing is applied to restructure the multistage data structure in which each stage will be strata, group or cluster, reservoir or block, gap or blast data distribution in case of condensation or incremental or sampling-based methods.

STEP3: Then ranking is applied into the multistage features of multistage data structure to retrieve the representative samples based on the proposed representative described previously.

STEP4: Bring the required percentage of the representative samples in case of finite data at rest based on the available memory in the infrastructure (the previously described techniques will be applicable; see e.g. FIG. 9).

STEP5: Initially global layer in [A_{t,d,i,m}^{f,q}]_{r=1,j=1}^{q,m} q-by-m features global space [symbol] _{t,d}^{G,f,q} will partitioned the data set {X_{t,d,n}^{f}}ᵢ₌₁ⁿ into some number of K clusters whose resultant cluster set is {C_{1,p,f}^{l}^{ₐ}^{,l}^{ₑ}, C_{2,p,f}^{l}^{ₐ}^{,l}^{ₑ}, . . . , C_{k,p,f}^{l}^{ₐ}^{,l}^{ₑ}}. Where G is the notation for the global in the global space [symbol] _{t,d}^{G,f,q}. The resultant global layer cluster set {C_{K,p,f}^{l}^{ₐ}^{,l}^{ₑ}}ₖ₌₁^{K} will be obtained by solving the mathematical problem shown in STEP6 which will be based any one of the categories of clustering algorithm based on probabilistic or distance or density or grid search. In case where layer lₐ is a global layer, the resultant global layer cluster sets {C_{K,p,f}^{l}^{ₐ}^{,l}^{ₑ}}ₖ₌₁^{K} contains the sets of instance or observations or data points in each cluster and these sets satisfy the following properties.
C_{1,p,f}^{l}^{ₐ}^{,l}^{ₑ}∪C_{2,p,f}^{l}^{ₐ}^{,l}^{ₑ}∪C_{3,p,f}^{l}^{ₐ}^{,l}^{ₑ} . . . ∪C_{k,p,f}^{l}^{ₐ}^{,l}^{ₑ}={X_{t,d,n}^{f}}ᵢ₌₁ⁿ. In other words, each observation in global layer in lₑ th level and in p th phase is belonging to at least in one of the K clusters.
C_{k,p,f}^{l}^{ₐ}^{,l}^{ₑ}∩C_{k′,p,f}^{l}^{ₐ}^{,l}^{ₑ}=Ø for all k=k′. In other words, the clusters are non-overlapping or distinct in the case of non-overlapping or nonfuzzy clustering. No observations belong to more than one clusters.
C_{k,p,f}^{l}^{ₐ}^{,l}^{ₑ}∩C_{k′,p,f}^{l}^{ₐ}^{,l}^{ₑ}=Ø for all k=k′. In other words, the clusters are overlapping or non-distinct in the case of overlapping or fuzzy clustering. Observations belong to more than one clusters.
For instance, if the i^{th} observation in global layer in lₑ^{th} level and in p^{th} phase is in the k^{th} cluster, then i∈C_{k,p,f}^{l}^{ₐ}^{,l}^{ₑ}.
   Where, lₐ: number of layer, lₑ: number of level, p: number of phase, f: dataset at rest or finite dataset or streaming dataset, k: number of clusters, C: represents cluster.

STEP6: The algorithm aims to find the resultant global layer cluster set {C_{K,p,f}^{l}^{ₐ}^{,l}^{ₑ}}ₖ₌₁^{K} of by lₑ^{th} level and p^{th} phase by minimising the global cost function or global distortion measure [symbol] _{t,d}^{f,G}. For examples in the case of partitional iterative based clustering minimize the within-cluster variation for cluster as small as possible. The proposed mathematical global cost function or global object function or global distortion measure, shown below

$${𝒥}_{t , d}^{f , G} ( {U}^{G} , {V}^{G} ) = {arg min}_{{S}_{t , d}^{f , q}} {\sum }_{c = 1}^{k} {\sum }_{{x}_{t , d , n}^{f} ∈ {S}_{t , d , i = 1}^{f , q}}^{n} {u}_{c , i}^{G , m} {D}_{c , i}^{G}$$

Where U^{G}=[u_{c,i}^{G,m}] is a k-by-n global layer cluster matrix and u_{c,i}^{G,m}∈{0,1}, denotes the degree of i^{th} object to the c^{th} global cluster for i≠c,
V^{G}=[v_{f,p,1}^{G,l}^{ₑ}, v_{f,p,2}^{G,l}^{ₑ}, . . . , v_{f,p,f}^{G,l}^{ₑ}] is the global cluster centre matrix,
v_{f,p,i}^{G,l}^{ₑ}=[v_{f,p,i,1}^{G,l}^{ₑ}, v_{f,p,i,2}^{G,l}^{ₑ}, . . . , v_{f,p,i,m}^{G,l}^{ₑ}] is the i^{th} global cluster centre in lₑ^{th} level p^{th} phase with m features.

For example, in case of partitional iterative based clustering, the global layer cost function can be solved by solving the mathematical problem shown below

$${𝒥}_{t , d}^{f , G} = {\sum }_{c = 1}^{k} {\sum }_{{x}_{t , d , n}^{f} ∈ {S}_{t , d , i = 1}^{f , q}}^{n} {r}_{n , c}^{f , q , G} {D}_{c , i}^{f , q , G}$$

Subject to q=numeric/image/text.

$${S}_{t , d}^{f , q = numeric / image / text} = \{ {x}_{t , d , 1 , 1}^{f} , {x}_{t , d , 2 , 1}^{f} , .. , {x}_{t , d , n , 1}^{f} \} , … , \{ {x}_{t , d , 1 , m}^{f} , {x}_{t , d , 2 , m}^{f} , .. , {x}_{t , d , n , m}^{f} \}$$

Our goal is to find the values for the {r_{n,c}^{f,q,G}} and {μ_{t,d,c}^{f,q}}, In order to minimize the global object function or global cost function or global distortion measure [symbol] _{t,d}^{f,G}, which can be achieved by iterative procedure.
Where, the U^{G}=[r_{n,c}^{f,q,G}] is a c-by-n matrix,

$${r}_{n , c}^{f , q , G} = \{ \begin{matrix}1 , & if c = arg {min}_{k} {‖ {x}_{t , d , n}^{f , q} - {μ}_{t , d , k}^{f , q} ‖}^{2} \\ 0 , & otherwise\end{matrix}$$

Where D_{c,i}^{f,q,G} is the within cluster variation distance function.

For example, in case of a within cluster variation distance function based on Manhattan distance, the absolute differences between coordinates of pair of objects are computed as shown below

$${D}_{c , i}^{f , q , G} = {\sum }_{c = 1}^{k} {\sum }_{{x}_{t , d , n}^{f} ∈ {S}_{t , d , i = 1}^{f , q}}^{n} ‖ {x}_{t , d , n}^{f , q} - {μ}_{t , d , c}^{f , q} ‖$$

In case the within cluster variation distance function is based on Minkowski Distance which is the generalized metric distance, this is calculated based on the equation shown below

$${D}_{c , i}^{f , q , G} = {\sum }_{c = 1}^{k} {\sum }_{{x}_{t , d , n}^{f} ∈ {S}_{t , d , i = 1}^{f , q}}^{n} {( {‖ {x}_{t , d , n}^{f , q} - {μ}_{t , d , c}^{f , q} ‖}^{1 / a} )}^{a}$$

Note: When a=1, the distance become city block distance and when a=2, the distance become Euclidean distance. Chebyshev distance is a variant of Minkowski distance where p=∞ (taking a limit). This distance can be used for both ordinal and quantitative variables

In case the within cluster variation distance function is based on Euclidean distance, this computes the root of square difference between co-ordinates of pair of objects as shown below

$${D}_{c , i}^{f , q , G} = \sqrt{{\sum }_{c = 1}^{k} {\sum }_{{x}_{t , d , n}^{f} ∈ {S}_{t , d , i = 1}^{f , q}}^{n} {‖ {x}_{t , d , n}^{f , q} - {μ}_{t , d , c}^{f , q} ‖}^{2}}$$

STEP7: Once the global layer clustering is calculated then the local layer clusters will be calculated by solving the local layer mathematical problem based on the selected business problem. The lₑ^{th} level p^{th} phase global layer space [symbol] _{t,p,d}^{G,l}^{ₑ}^{,f} will be partitioned into number of local layer space { [symbol] _{t,p,d}^{l}^{ₒ}^{,l}^{ₑ}^{,f}}ᵢ₌₁^{l}^{ₒ} where { [symbol] _{t,p,d}^{1,l}^{ₑ}^{,f}, [symbol] _{t,p,d}^{2,l}^{ₑ}^{,f}, . . . , [symbol] _{t,p,d}^{l}^{ₒ}^{,l}^{ₑ}^{,f}}∈_{t,p,d}^{G,l}^{ₑ}^{,f}. If the local layer lₑ^{th} level p^{th} phase local layer is greater than one i.e lₐ^{local}>1 then each local layer will solve each local layer mathematical problem in parallel in order to reduce the computational time, if the computer resource or infrastructure is multicore threaded system. If the computational resource is limited to single core (single-threaded), then each local layer's business problem will be computed sequentially.

### Computer System

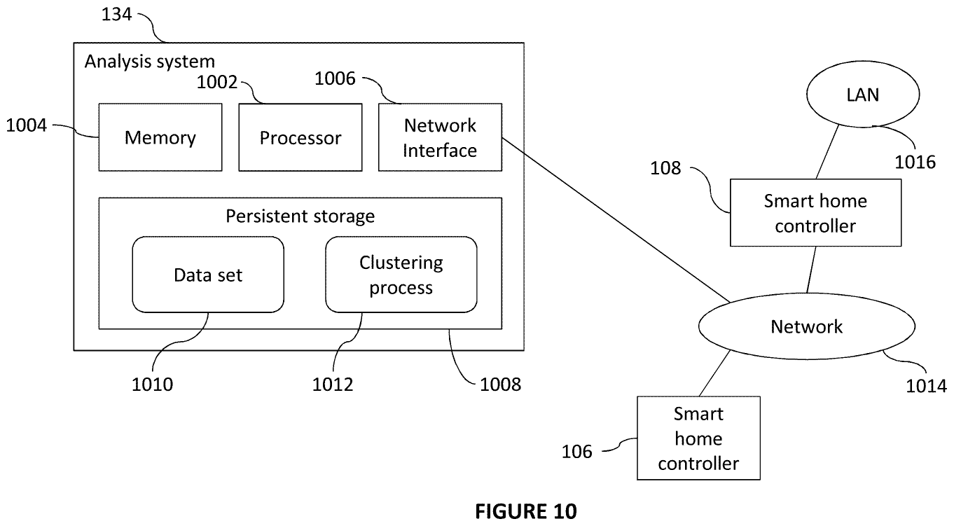

FIG. 10 illustrates the hardware/software architecture of a processing system suitable for implementing described processes. The system includes the analysis system 134 e.g. in the form of a server computer. The server includes one or more processors 1002 (e.g. standard Intel/AMD server processors) together with volatile/random access memory 1004 for storing temporary data and software code being executed.

A network interface 1006 is provided for communication with other system components (in particular smart home control systems 106, 108) over one or more networks 1014 (e.g. Local or Wide Area Networks, including the Internet). Smart home controllers themselves are connected to local devices via a local network 1016, which in one example may include a local wireless network installed in the property for supporting smart home functions, e.g. based on WiFi, Bluetooth, Zigbee or other communications standards and protocols.

Persistent storage 1008 (e.g. in the form of hard disk storage, optical storage and the like) persistently stores the data set 1010 of data records received at the server 134 from the smart home systems, together with software modules for performing the described functions, in particular clustering process 1012 for implementing the various described clustering techniques.

The persistent storage also includes other software and data (not shown), such as an operating system. Furthermore, the server will include other conventional hardware and software components as known to those skilled in the art, and the components are interconnected by data buses (e.g. in the form of a memory bus between memory 1004 and processor 1002, and an I/O bus between the processor 1002, network interface 1006 and a storage controller for persistent storage 1008 etc.)

While a specific architecture is shown by way of example, any appropriate hardware/software architecture may be employed. Furthermore, functional components indicated as separate may be combined and vice versa. For example, the functions of server 134 may in practice be implemented by multiple separate processing devices. The server may be provided in the form of a cloud server connected to the smart home controllers over the Internet.

The smart home controllers themselves are similarly implemented using conventional computer hardware (e.g. comprising local processor, persistent and volatile memory), though these may typically be more limited in processing capability.

It will be understood that the present invention has been described above purely by way of example, and modification of detail can be made within the scope of the invention.

What is claimed is:

1. A computer-implemented method of clustering data in a data set comprising a plurality of data records each having respective attribute values for a plurality of attributes, the method comprising:
receiving clustering parameters comprising:
a cluster count specifying a number of clusters to be generated; and
a partitioning attribute, specifying a selection of a given attribute of the plurality of attributes of the data records;
identifying a plurality of partitions of the data set based on values of the partitioning attribute;
generating a plurality of initial cluster centres, each cluster centre defined for one of the partitions, the generating step comprising allocating initial cluster centres to each of a plurality of partitions in proportion to a number of data records in the respective partition;
running a clustering algorithm using the generated initial cluster centres to define starting clusters for the clustering algorithm, the clustering algorithm identifying a plurality of clusters based on the initial cluster centres; and
outputting data defining the identified clusters.

2. The method according to claim 1, wherein the partitioning attribute includes one of:
categorical data, the method comprising identifying a respective partition for each distinct category value in the partitioning attribute; and
non-categorical data, the method comprising identifying a respective partition for each of a plurality of distinct categories derived from values in the partitioning attribute, wherein a category is derived for each of a set of distinct value ranges of a numerical partitioning attribute.

3. The method according to claim 1, comprising allocating initial cluster centres to partitions, the allocating comprising at least one of:
allocating initial cluster centres to partitions proportionally to a number of data records in respective partitions;
where the number of partitions is less than the cluster count, allocating multiple initial cluster centres to one or more partitions with the most data records;
where the number of partitions is greater than the cluster count, allocating a single initial cluster centre to each of a selected set of partitions, the selected set of partitions comprising those with the most data records; and
allocating a plurality of the initial cluster centres to a given partition by subpartitioning the given partition based on a second partitioning attribute, and allocating at least one initial cluster centre to one or more of the subpartitions.

4. The method according to claim 1, wherein generating the initial cluster centre for one or more of the partitions comprises selecting the initial cluster centre randomly within a feature space defined by values of the data records in the partition, the selecting comprising one of: selecting a random record of the partition as basis for the initial cluster centre, and selecting the initial cluster centre from the records in the partition based on a density function.

5. The method according to claim 1, further comprising sampling the data set by selecting a subset of records from respective partitions, wherein initial cluster centres for respective partitions are generated based on the selected records of the partitions.

6. The method according to claim 1, wherein the clustering algorithm identifies the plurality of clusters by a process comprising: assigning data records to the starting clusters defined by the initial cluster centres, and re-computing initial cluster centres based on data records assigned to the corresponding clusters, the assigning and re-computing repeated until a termination criterion is met.

7. The method according to claim 1, the method comprising:
for each of a plurality of segments of the data set, each segment comprising a subset of records of the data set:
retrieving a plurality of data records of the segment from storage;
performing an initial clustering process on the retrieved data records to identify a set of clusters, each cluster defined by a representative data record;
performing a further clustering process on the representative data records defining the clusters found for each segment to identify a second set of clusters; and
wherein the outputting step comprises outputting data defining the second set of clusters.

8. The method according to claim 7, wherein each segment is selected based on an amount of available memory of a processing system performing the method, wherein each segment is sized to fit in the available memory.

9. The method according to claim 1, comprising receiving one or more further data records and classifying the one or more further data records based on the cluster definition data output in the outputting step, wherein the cluster definition data comprises the cluster centre for each cluster.

10. The method according to claim 1, wherein the data records are received from one or more remote client systems at a central processing system performing the clustering, the method further comprising controlling one or more client systems or devices connected thereto based on the identified clusters and/or based on classification of further data records using the identified clusters; wherein the outputting step comprises transmitting the cluster definition data to the client systems, and using the cluster definition data at the client systems to classify subsequent data records and/or control one or more devices connected to the client systems, wherein the client systems receive the data records from the one or more connected devices or generate the data records based on data received from the one or more connected devices.

11. A computer-implemented method of clustering data in a data set comprising a plurality of data records each having respective attribute values for a plurality of attributes, the method comprising:
receiving a partitioning attribute, specifying a user selection of a given attribute of the plurality of attributes of the data records;
identifying a plurality of partitions of the data set based on values of the selected partitioning attribute, each partition representing a different category of one or more values of the partitioning attribute;
wherein each category corresponds to one or more predefined discrete values of the selected partitioning attribute;
sampling the data set by selecting a subset of records from respective partitions, wherein the number of records selected from a partition is proportional to the size of the category, resulting in a sample set of records from the data set;
running a clustering algorithm on the sample set of records, the clustering algorithm identifying a plurality of clusters based on the sample set; and
outputting data defining the identified clusters.

12. The method according to claim 11, wherein the number of records selected from respective partitions is further dependent on a total required sample size and/or wherein the number of records selected from the partition is proportional to the size of the partition, in accordance with a required sampling ratio.

13. The method according to claim 11, comprising subpartitioning a given partition in dependence on at least one further partitioning attribute, and selecting sampled records for the given partition from respective subpartitions in dependence on sizes of the subpartitions.

14. The method according to claim 11, wherein the sampling is performed using random gap sampling.

15. A computer-implemented method of clustering data in a data set comprising a plurality of data records each having respective attribute values for a plurality of attributes, the method comprising:
receiving a data type selection specifying one of a plurality of data types;
deriving reduced feature vectors from data records of the data set, wherein a reduced feature vector comprises a set of attributes selected from the data records having the selected data type;
running a clustering algorithm to identify a plurality of clusters in the data records, wherein the clustering algorithm clusters the derived reduced feature vectors to identify a plurality of data clusters;
performing each clustering pass using a different similarity or distance metric selected in dependence on the data type; and
outputting data defining the identified clusters.

16. The method according to claim 15, comprising at least one of: repeating the clustering for each of the plurality of data types; performing the clustering in parallel for each of the plurality of data types.

17. A computer-implemented method of clustering data in a data set comprising a plurality of data records, the method comprising:
running a clustering process to identify a plurality of clusters in the data records at a first level of clustering;
running a clustering process at one or more further levels of clustering, wherein the clustering process at a given further level identifies, for each of a plurality of higher-level clusters identified at a preceding level of clustering, a plurality of subclusters by clustering data records of the respective higher-level cluster;
wherein clustering at each of the first and further levels of clustering is performed based on a clustering strategy selected from a plurality of available clustering strategies which is applied to records in the data set or in a cluster of records identified in a previous clustering level;
wherein the clustering strategy used at each level of clustering is configurable and specified by way of one or more clustering parameters; and
wherein the clustering process uses at least two different clustering strategies at respective different levels of clustering as specified by the clustering parameters for the respective levels of clustering.

18. The method according to claim 17, wherein the available clustering strategies comprise one, several, or each of:
clustering data records based on initial clusters selected for a plurality of data partitions in accordance with one or more selected partitioning attributes;
clustering data records based on initial clusters identified by random centroid selection within an unpartitioned set of records to be clustered;
clustering data records based on reduced feature vectors selected in dependence on data types of attributes of the data records.

19. The method according to claim 17, comprising, at a given clustering level, performing subclustering in parallel for a plurality of clusters identified in a preceding level of clustering.

20. The method according to claim 17, wherein clustering at one or more of the further clustering levels is performed on a reduced set of records obtained by sampling a cluster identified in a preceding level of clustering.
